(19) United States
(12) Patent Application Publication
(10) Pub. No.: US 2009/0208778 A1
(43) Pub. Date: Aug. 20, 2009

(54) Patterned magnetic recording medium and method for manufacturing same

(75) Inventor: Michiko Horiguchi, Hino City (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd., Tokyo (JP)

(21) Appl. No.: 12/321,000

(22) Filed: Feb. 10, 2009

(30) Foreign Application Priority Data
Feb. 19, 2008 (JP) PA 2008-037785

(51) Int. Cl. G11B 5/72; G11B 5/66; B05D 3/06

(52) U.S. Cl. 428/832; 427/532

(57) ABSTRACT

A patterned magnetic recording medium includes a magnetic layer having a track-shape and/or dot-shape relief pattern which demarcates information recording regions; a first protective layer covering the magnetic layer; and a second protective layer formed on the first protective layer and including a tetrahedral carbon (ta-C) film. The first protective layer has excellent corrosion resistance and the second protective layer has excellent magnetic head sliding characteristics. A method for manufacturing the medium includes forming an etching pattern of photohardening etching resist on an underlayer or magnetic layer using an imprinting method and etching the underlayer or magnetic layer to form a relief pattern; forming the first protective layer on the relief pattern of the magnetic layer using plasma CVD; and forming the second protective layer including a tetrahedral carbon (ta-C) film, on at least respective top portions of the relief pattern, by a FCA method or by a FCVA method.

### CROSS-REFERENCE TO RELATED APPLICATION

This Application claims the benefit of the priority of Applicant's earlier filed Japanese Patent Application No. 2008-037785, filed Feb. 19, 2008, the contents of which are incorporated herein by reference.

### BACKGROUND OF THE INVENTION

1. Field of the Invention

This invention relates to a magnetic recording medium, more specifically, to a patterned magnetic recording medium in which information recording regions are demarcated as a track-shape and/or dot-shape relief pattern, and to a method for manufacturing such a patterned magnetic recording medium.

2. Background of the Related Art

The recording capacity of magnetic recording media is rising rapidly, as a result of development of magnetic materials required for such media, adoption of perpendicular magnetization methods, narrowing of the gap between the magnetic head and the magnetic recording media surface through reduction of the magnetic head flying height during writing and reading by magnetic recording devices, and other factors.

Such magnetic recording media generally has a structure in which a magnetic layer and a protective layer are sequentially layered, via an underlayer, on a nonmagnetic substrate such as a metal substrate made of aluminum or the like, a glass substrate, and a plastic film substrate.

A protective layer has been used in essence to shield the magnetic layer, comprising metal components, from the outside environment; inorganic thin films, nonmagnetic metal films, and the like have been used with the objective of preventing corrosion. As magnetic head flying heights have been reduced, thinner protective layers have been sought and carbonaceous films in various forms have been used for this purpose due to their resistance to damage upon contact with magnetic heads, wear resistance, the excellent adhesion of lubricants applied onto the protective layer, and for other reasons.

Such carbonaceous films include graphite films, formed by magnetron sputtering using graphite as a target; diamond-like carbon (DLC) films, formed by the plasma CVD method using as raw materials hydrocarbons such as methane, ethane, propane, butane, or other alkanes, ethylene, propylene, or other alkenes, acetylene or other alkyenes, or the like; and tetrahedral carbon (ta-C) films, formed by the Filtered Cathodic Arc (FCA) method in which a pure graphite target is used as a cathode and discharge is induced to cause an arc at the target and generate carbon plasma, with the carbon plasma arranged on a base to deposit a carbon film, or by the Filtered Cathodic Vacuum Arc (FCVA) method; and the like. A protective layer comprising a two-layer structure, in which a ta-C film is layered on a DLC film formed by the plasma CVD method, has been proposed (see, for example, Japanese Patent Application Laid-open No. 2003-346322 (which corresponds to U.S. Published Application No. 2003/228496A1) and Japanese Patent Application Laid-open No. 2004-054991 (which corresponds to U.S. Published Application No. 2003228496A1), and the like.

As next-generation magnetic recording media, discrete track media (DTM) and bit pattern media (BPM), in which information recording regions are demarcated as nanometer-order relief patterns having track shapes and dot shapes, with various data magnetically recorded to the convex portions and/or concave portions, and other types of patterned magnetic recording media have been proposed (see, for example, Japanese Patent Application Laid-open No. 2003-203301 and Japanese Patent Application Laid-open No. 2003-123201, and the like).

The above-described ta-C film is a fine-textured film with bulk hardness of 65 to 75 GPa, which provides a higher hardness compared to the 10 to 35 GPa obtained by DLC films formed by the plasma CVD method, and so is promising as a protective film for magnetic recording media. However, even when a single layer of ta-C is formed on a magnetic layer, it is extremely difficult to obtain all the desired characteristics sought from a protective layer.

In Japanese Patent Application Laid-open No. 2003-346322 (which corresponds to U.S. Published Application No. 2003/228496A1) and Japanese Patent Application Laid-open No. 2004-054991 (which corresponds to U.S. Published Application No. 2003/228496A1), use of a two-layer structure composed of a ta-C layer and another carbon layer as the protective layer formed on a flat magnetic layer is proposed as a means of preventing degradation of the magnetic recording layer accompanying ion implantation during ta-C layer formation, and of improving adhesion between the protective layer and the lubricant layer formed thereupon.

The above proposals are both premised on formation of a protective layer comprising a two-layer structure on a flat magnetic layer. Issues arising upon application of such proposals for the protective layer in patterned magnetic recording media have not been studied, however, because, in contrast with magnetic recording devices employing conventional CSS (contact start-stop) methods, magnetic recording devices adopting patterned magnetic recording media having a relief pattern and which are being studied as next-generation magnetic recording media, such as DTM and BPM, a method is employed in which the magnetic head performs information writing/reading while sliding in contact on the magnetic recording media.

In patterned magnetic recording media such as DTM and BPM in which the magnetic layer has a relief pattern, the protective layer for the magnetic layer with the relief pattern is required to have adequate corrosion resistance to prevent corrosion and, in addition, must have satisfactory sliding characteristics with respect to magnetic head contact.

When the FCA method or FCVA method is used to form a single ta-C layer, with high hardness and good sliding characteristics, as the protective layer of a magnetic layer having a relief pattern, it is difficult to obtain a uniform film along the relief pattern because of the high rectilinearity of carbon plasma, and corrosion occurs from areas in which the film is not readily formed, so that the film does not function as a protective layer. Moreover, compared with DLC films, ta-C films crack more readily when a force acts in the perpendicular direction, and corrosion of the magnetic layer occurs from cracked portions.

Further, in both Japanese Patent Application Laid-open No. 2003-203301 and Japanese Patent Application Laid-open No. 2003-123201, which disclose patterned magnetic recording media, there is no description of a specific method for formation of a nanometer-order relief pattern in a magnetic layer.

Accordingly, this invention has as an object the provision of a patterned magnetic recording medium in which information recording regions are demarcated as a track-shape and/or dot-shape relief pattern, in which corrosion of the magnetic layer having a relief pattern corresponding to this relief pattern is prevented, and which has excellent sliding characteristics with respect to magnetic heads, as well as a method for manufacturing such a medium.

### SUMMARY OF THE INVENTION

As a result of assiduous studies to attain the above object, the inventor discovered that, by using an imprinting method, which is preferably a nano-imprinting method, a magnetic layer having a relief pattern corresponding to a desired relief pattern, which is preferably a nanometer-order relief pattern, demarcating information recording regions could easily be formed. Moreover, the inventor discovered that, by using the CVD method to form a protective layer comprising a DLC film on the magnetic layer thus formed with the relief pattern and forming on this DLC film a ta-C film by the FCA method having higher hardness than the DLC film, adequate corrosion resistance of the magnetic layer having the relief pattern as well as satisfactory sliding characteristics with respect to a magnetic head could be obtained, thus realizing this invention.

The patterned magnetic recording medium of this invention is a magnetic recording medium in which information recording regions are demarcated as a track-shape and/or dot-shape relief pattern, and comprises a base; an underlayer positioned on the base; a magnetic layer positioned on the underlayer and having a relief pattern which corresponds to the information recording regions and which includes a convex pattern and a concave pattern; a first protective layer covering the magnetic layer and having the relief pattern which includes the convex pattern and the concave pattern; and a second protective layer formed on at least respective top portions of the convex pattern of the first protective layer and comprised of a tetrahedral-carbon (ta-C) film formed by an FCA method or an FCVA method.

The information recording regions may be demarcated by at least the convex pattern in the magnetic layer having the relief pattern, or may be demarcated by both the convex pattern and a concave pattern.

It is preferable that the first protective layer be an inorganic film or a carbonaceous film formed by the plasma CVD method, and still more preferable that the first protective layer be a diamond-like carbon (DLC) film formed by the plasma CVD method.

A method for manufacturing a patterned magnetic recording medium of this invention comprises the steps of: (a) forming a magnetic layer, having a relief pattern which corresponds to a track-shape and/or dot-shape relief pattern demarcating information recording regions and which includes a convex pattern and a concave pattern, on an underlayer positioned on a base, by: (1) forming an etching pattern of photohardening etching resist on the underlayer or the magnetic layer or a temporary protective layer; and (2) etching the underlayer or magnetic layer or temporary protective. layer and the magnetic layer along the etching pattern to form a relief pattern in the underlayer or the magnetic layer; (b) forming a first protective layer on the magnetic layer having the relief pattern by forming an inorganic film or a carbonaceous film by a plasma CVD method; and (c) forming a second protective layer comprising a ta-C film on at least respective top portions of the convex pattern of the first protective layer, by using an FCA method or an FCVA method.

The step of forming an etching pattern of a photohardening etching resist on the underlayer or magnetic layer or a temporary protective layer suitably comprises applying the photohardening etching resist onto the underlayer or magnetic layer or the temporary protective layer; pressing a quartz mold, having a relief pattern, onto the applied resist film in an imprinting method; and irradiating with ultraviolet rays through the quartz mold to harden the resist and form the etching pattern. Preferably the quartz mold has a nanometer-order relief pattern, and wherein the imprinting method is a nano-imprinting method

It is preferable that forming the first protective layer comprises forming a diamond-like carbon (DLC) film by the plasma CVD method.

The patterned magnetic recording medium of this invention has a second protective layer comprising ta-C film, with superior sliding characteristics, on a first protective layer, so that during information writing/reading, sliding while the magnetic head is in contact with the magnetic recording medium is possible, and as a result of reducing the gap between the magnetic head and the magnetic layer to effectively the total thickness of the first protective layer and the second protective layer on the magnetic layer, large recording capacities can be attained, and in addition to normal information, there is the advantage that information intrinsic to the magnetic recording medium, such as manager information, information types, information readout numbers, and other operation-related information, as well as other information can be registered in individual track-shape or dot-shape relief patterns demarcated as information recording regions.

Further, by covering information recording regions comprising the magnetic layer formed as a relief pattern up to the corner of bottom thereof with a first protective layer having excellent covering properties, satisfactory corrosion resistance is obtained, and by positioning the second protective layer of ta-C film on the top portion of the convex pattern of the first protective layer in contact with the magnetic head, extremely good magnetic head sliding characteristics are obtained.

Further, in a patterned magnetic recording medium manufacturing method, by using a nano-imprinting method, information recording regions comprising the magnetic layer having a desired nanometer-order relief pattern can be demarcated easily.

### BRIEF DESCRIPTION OF THE VARIOUS VIEWS OF THE DRAWING

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a cross-sectional view showing one aspect of a patterned magnetic recording medium of the invention;

FIG. 2 is a graph showing results of a metal elution test 1 for Example 1;

FIG. 3 is a graph showing results of sliding tests for Example 1;

FIG. 4 is a graph showing results of a metal elution test 2 for Example 1; and

FIG. 5 is a diagram of processes for formation of a relief pattern in an underlayer or magnetic layer.

### DETAILED DESCRIPTION OF THE INVENTION

In this specification, “a patterned magnetic recording medium” is a magnetic recording medium in which information recording regions, comprising a magnetic layer on a base, is positioned as a relief pattern, which is preferably a nanometer-order relief pattern, having a track shape and/or a dot shape, and in which the convex portions and/or concave portions of the relief pattern are demarcated as information recording regions.

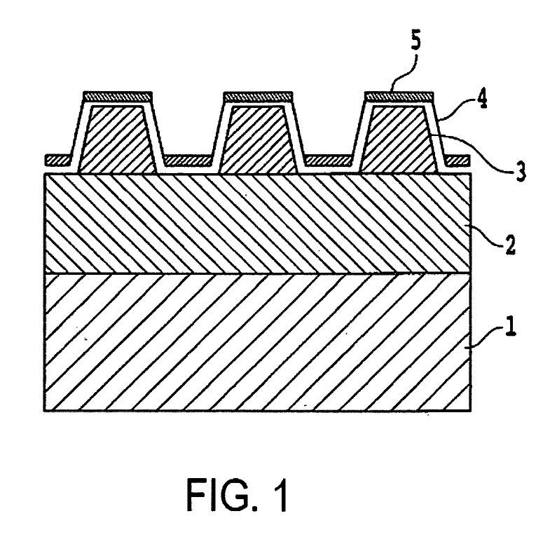

The patterned magnetic recording medium of this invention is explained based on FIG. 1, showing a first aspect thereof. In FIG. 1, a patterned magnetic recording medium comprises a base 1; underlayer 2 on the base 1; magnetic layer 3, with a relief pattern, which preferably is a nanometer-order relief pattern, having a track shape and/or dot shape, positioned on the underlayer 2; first protective layer 4, covering the entirety of the relief pattern of the magnetic layer 3, as is preferred; and second protective layer 5, comprising a tetrahedral carbon (ta-C) film, covering the top portions and bottom portions of the relief pattern.

In this invention, the base 1 is any of the various types of base normally used in magnetic recording media such as, for example, a glass substrate, a ceramic substrate, a plastic substrate, a nonmagnetic metal substrate, or various other substrates, as well as a nonmagnetic metal drum, and the like.

The underlayer 2 comprises a nonmagnetic or soft magnetic material, such as Co, a CoNi system alloy, or various other materials having perpendicular magnetic anisotropy, as well as PERMALLOY or other soft magnetic materials, and either has a flat surface, or has a surface with a relief pattern, such as a nanometer-order relief pattern, corresponding to that of the magnetic layer 3.

The magnetic layer 3 is a layer comprising a magnetic metal, such as Co, Cr, Ni, Pt, or an alloy comprising any of these, and has a relief pattern, preferably a nanometer-order relief pattern, the widths of the convex portions and concave portions thereof corresponding to the track-shape and/or dot-shape patterns demarcating information recording regions being 100 nm or less, preferably 10 nm to 60 nm, with a depth of 50 nm or less, preferably 10 nm to 40 nm. The magnetic layer 3 is positioned at least in the convex portion pattern of the relief pattern, but may be positioned in both the convex portion pattern and in the concave portion pattern.

The first protective layer 4 comprises a metal oxide film such as SiO₂, metal nitride film, or other inorganic film, or a graphite film, diamond-like carbon (DLC) film, or other carbonaceous film, of thickness 5 nm or less, preferably 2.5 to 3.5 nm, with comparatively low hardness and excellent covering characteristics. It is particularly preferable that the first protective layer 4 comprise a DLC film of film thickness 1 to 3 nm, formed by the plasma CVD method.

On the other hand, the second protective layer 5 comprising a ta-C film is a carbonaceous film having extremely high hardness formed by the FCA method or the FCVA method, and preferably has a film thickness of 2.5 nm or less, more preferably 1 nm or less, and still more preferably 0.3 to 0.7 nm, and is positioned on at least the top portions of the convex pattern of the first protective layer having a relief pattern.

The first protective layer 4 covers the relief pattern on the base 1 and prevents corrosion of the metal components comprised by the magnetic layer 3 and by the underlayer 2. On the other hand, the second protective layer (ta-C film) 5, positioned on at least the top portions of the convex pattern of the relief pattern of the first protective layer 4, improves the sliding characteristics with respect to the magnetic head which slides in contact therewith.

This patterned magnetic recording medium of the invention is manufactured by forming, on the base 1, the magnetic layer 3 which has a relief pattern, preferably a nanometer-order relief pattern, corresponding to a track-shape and/or dot-shape relief pattern which demarcates information recording regions, and then forming on the relief pattern thus formed, the first protective layer 4 and the second protective layer 5 comprising a ta-C film.

The magnetic layer 3 having the relief pattern, preferably the nanometer-order relief pattern, is fabricated either by a method, after forming the underlayer 2 and magnetic layer 3 on the base 1 or after further forming a temporary protective layer 4a on the magnetic layer 3, of etching the magnetic layer 3 or the temporary protective layer 4a and magnetic layer 3, or by a method of etching the underlayer 2 formed on the base 1 to form a nanometer-order relief pattern in the underlayer 2, and then forming the magnetic layer 3 on the underlayer 2. The former method is suitable for manufacturing a patterned magnetic recording medium when the magnetic layer 3 is positioned only in the convex pattern or in both the convex pattern and the concave pattern, while the latter method is suitable for manufacturing a patterned magnetic recording medium in which the magnetic layer 3 is positioned in both the convex pattern and in the concave pattern.

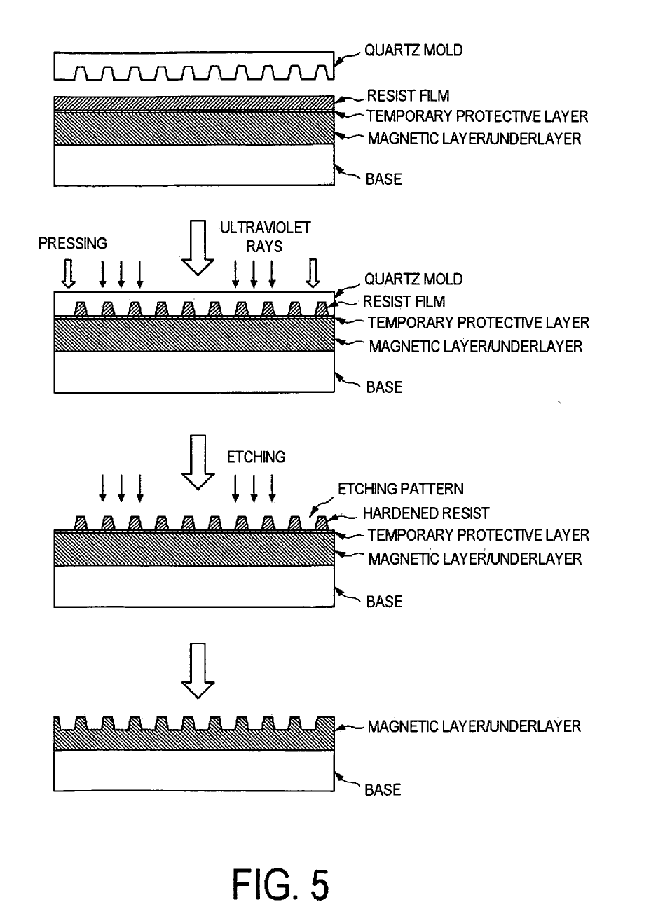

As shown in FIG. 5, the underlayer 2 or magnetic layer 3 having a relief pattern, preferably a nanometer-order relief pattern, can be fabricated by an imprinting method, preferably a nano-imprinting method, in which a photohardening etching resist is applied onto the underlayer 2 or magnetic layer 3 or else onto a temporary protective layer 4a, a quartz mold in which is formed the desired relief pattern is pressed onto the applied resist film, the applied resist film is irradiated with ultraviolet rays through the quartz mold and hardened to form an etching pattern, and the underlayer 2 or magnetic layer 3 is etched to a desired depth along this etching pattern.

In the above method, no limitations in particular are placed on the methods used to form the underlayer 2 on the base 1, the magnetic layer 3 on the underlayer 2, or a temporary protective layer 4a on the magnetic layer 3, and well-known methods employed in manufacture of magnetic recording media of the prior art can be adopted.

Next, the first protective layer 4 is formed on the magnetic layer with a relief pattern obtained as described above, and then the second protective layer 5 comprising a ta-C film is formed at least on respective top portions of the convex pattern thereof.

No limitations in particular are placed on the method of formation of the first protective layer 4, and various well-known methods can be used. However, use of the plasma CVD method, which is capable of forming a uniform film on a relief pattern, is preferable. On the other hand, the FCA method or the FVCA method is used in formation of the second protective layer 5, comprising a ta-C film.

### EXAMPLES

The invention is explained in further detail by means of examples and comparative examples.

### Example 1

### Sample 1

An underlayer 2 of film thickness 30 nm, comprising a material containing at least one among Cr, Ti and Co, was formed by a sputtering method on a glass substrate 1. On this underlayer 2 was formed, by a sputtering method, a magnetic layer 3 of thickness 10 nm, comprising Co—Cr—Pt alloy. On the magnetic layer 3 was further formed, by the plasma CVD method, a temporary protective layer 4a of film thickness 4 nm comprising carbon.

Onto the temporary protective layer 4a thus obtained, a spin coater was used to apply by spin coating a UV-hardening etching resist (product name PAK-01, manufactured by Toyo Gosei) to a thickness of 40 nm, and after eliminating solvent at 80° C., a quartz mold, on which was formed a track-shape relief pattern, was pressed with a pressure of 0.1 MPa onto the surface of the applied film. After hardening the etching resist by irradiation with ultraviolet rays through the quartz mold, the quartz mold was removed, and a track-shape pattern for etching, having lines of width 60 nm, depth 40 nm, and intervals between lines of 40 nm, was formed on the magnetic layer 3.

Etching of the temporary protective layer 4a and magnetic layer 3 was performed, utilizing the difference in the relief film thicknesses of the etching pattern obtained and the difference in etch rates for different materials. The film was irradiated with argon ions at an accelerating voltage of 500 V, an ion beam current of 200 mA, and a gas pressure of 2.0×10⁻² Pa, and etching was performed until the temporary protective layer 4a on the protruding portions was removed. In order to adjust the taper angle, the substrate was inclined by 3° and was rotated at a rotation rate of 2 to 5 rpm. By this means, a track-shape relief pattern with line widths of 60 nm, groove widths of 40 nm, groove depths of 10 nm, and a taper angle of 60° was formed in the magnetic layer 3.

Plasma CVD was used with ethylene gas as the starting material to deposit a DLC film of thickness 2.0 nm, at a substrate temperature of 150° C. and a gas pressure of 0.1 to 0.7 Pa, onto the magnetic layer 3 with the relief pattern formed, to form the first protective layer 4 covering the magnetic layer 3 with the relief pattern.

Then, an FCA device was used to form a ta-C film 5 on the first protective layer 4, to a film thickness of 0.5 nm, to obtain a patterned magnetic recording medium (Sample 1) of this invention, in which the ta-C second protective layer 5 is formed on the top portions of the convex pattern and on the bottom portions of the concave pattern of the first protective layer.

### Comparative Sample 1

In the processes to fabricate the above Sample 1, the process of formation of the first protective layer 4 was omitted, and an FCA device was used to fabricate a ta-C film of thickness 2.5 nm directly onto the magnetic layer 3; otherwise processes similar to those used in fabricating Sample 1 were employed to obtain a patterned magnetic recording medium for comparison, Comparative Sample 1.

### Comparative Sample 2

On the magnetic layer 3 used in fabrication of Sample 1, prior to forming the relief pattern, the plasma CVD method was used to form a DLC film of thickness 2.0 nm under the same conditions as for Sample 1, and on this, an FCA device was used to deposit a ta-C film of thickness 0.5 nm, to obtain a magnetic recording medium for comparison, Comparative Sample 2.

### Comparative Sample 3

On the magnetic layer 3 used in fabrication of Sample 1, prior to forming the relief pattern, an FCA device was used to directly deposit a ta-C film of thickness 2.5 nm, to obtain a magnetic recording medium for comparison, Comparative Sample 3.

### Metal Elution Test 1

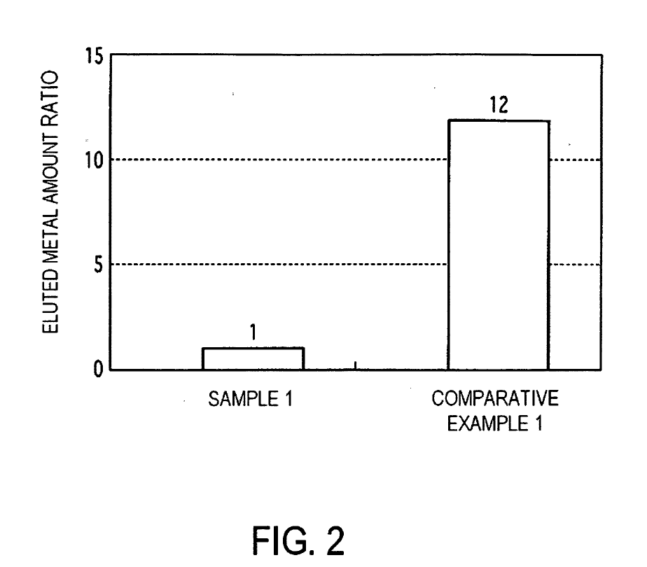

Sample 1 and Comparative Sample 1, after being left for 100 hours in an 80° C., 90% RH environment, were cut into square samples measuring 20 mm×20 mm, the peripheries were sealed with silicon resin, to prevent metal elution from a surface other than the surface on which the protective layers were formed, and after immersion for 30 minutes in a 1 wt % Na₂SO₄ aqueous solution at 20° C., the solution immersion potential was measured to analyze the quantity of eluted metal in the aqueous solution. Test results appear in FIG. 2. FIG. 2 shows the eluted metal amount for Comparative Sample 1, taking the eluted metal amount for Sample 1 to be 1.

FIG. 2 shows that in Sample 1, the DLC film formed by the CVD method on the magnetic layer 3 having a relief pattern functions adequately as a protective layer to prevent metal elution from the magnetic layer having the relief pattern.

On the other hand, in the case of the single ta-C film layer formed by the FCA method on the magnetic layer 3 having a relief pattern (Comparative Example 1), ion rectilinearity was high, and the film was formed selectively on the top portions of the convex pattern and on the bottom portions of the concave pattern, but was formed hardly at all on the rising portions of the relief pattern, so that metal was eluted from the rising portions of the relief pattern, and the film did not function as a protective layer to prevent metal elution from the magnetic layer.

### Sliding Tests

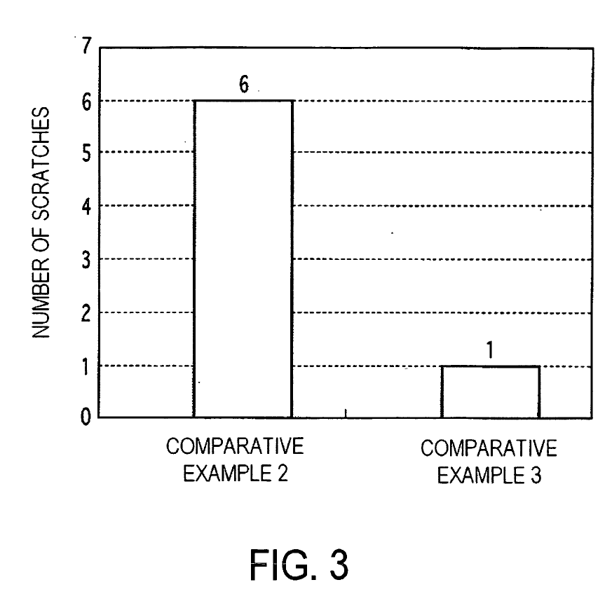

An AlTiC sphere of diameter 2.0 mm was pressed for one minute under a load of 5.0 gf against the surface of the medium of Comparative Samples 2 and 3, rotated at a rotation rate of 1.0 m/sec, after which the sample surfaces were irradiated with laser light and the reflected light was observed, to mount the number of scratches which had appeared in the surface. Measurement results are shown in FIG. 3.

FIG. 3 shows that a single ta-C film layer formed directly on a flat plate (Comparative Sample 3) is less prone to damage than a ta-C film formed on a DLC film on a flat plate (Comparative Example 2).

### Metal Elution Test 2

An AlTiC sphere of diameter 2.0 mm was pressed for one minute under a load of 5.0 gf against the surface of the medium of Sample 1 and Comparative Samples 2 and 3, rotated at a rotation rate of 1.0 m/sec; this sliding test was repeated 100 times, with a force repeatedly applied to the protective layer in the perpendicular direction.

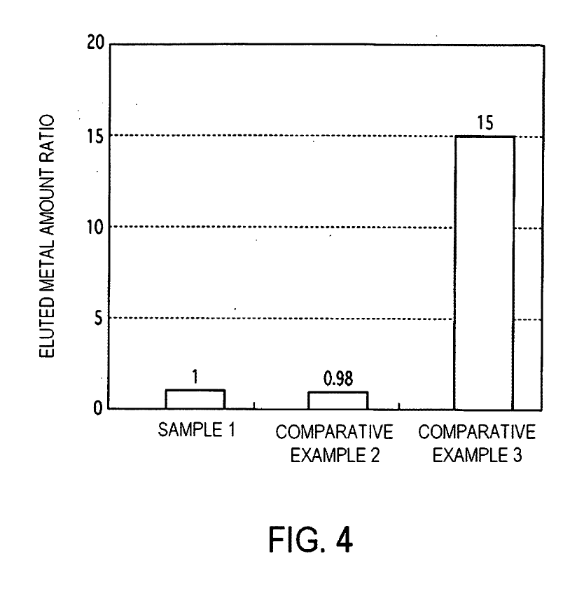

Samples subjected to the above sliding tests were left for 100 hours in an 80° C., 90% RH environment, and were then cut into square samples measuring 20 mm×20 mm, the peripheries were sealed with silicon resin, to prevent metal elution from a surface other than the surface on which the protective layers were formed, and after immersion for 30 minutes in a 1 wt % Na₂SO₄ aqueous solution at 20° C., the solution immersion potential was measured to analyze the quantity of eluted metal in the aqueous solution. Test results appear in FIG. 4. FIG. 4 shows the eluted metal amounts for Comparative Samples 2 and 3, taking the eluted metal amount for Sample 1 to be 1.

FIG. 4 shows that, regardless of the fact that the magnetic layer 3 had a relief pattern, in the case of Sample 1 the function of prevention of metal elution from the magnetic layer was substantially the same as for Comparative Example 2, in which the DLC film and ta-C film were formed directly on a flat-shape magnetic layer 3. On the other hand, in the case of Comparative Example 3, in which a single ta-C film was formed on a flat-shape magnetic layer 3, scratches in the ta-C film occurring in the sliding test resulted in loss of the function of magnetic layer protection.

### Example 2

The same fabrication method as for Sample 1 in Example 1 was employed, except that the thickness of the magnetic layer 3 was 20 nm and the etch depth of the magnetic film 3 was 10 nm, to fabricate a patterned magnetic recording medium, in which the magnetic layer had a track-shape relief pattern with line widths of 60 nm, groove widths of 40 nm, and groove depths of 10 nm, the magnetic layer 3 existed in the convex pattern, in the layer below the convex pattern, and in the bottom portions of the concave pattern, and which had a first protective layer comprising DLC film and a second protective layer comprising ta-C film. The patterned magnetic recording medium thus obtained was subjected to sliding tests and then to metal elution tests, and results similar to those for Sample 1 of the above Example 1 were obtained.

### Example 3

After forming the underlayer 2 of thickness 70 nm comprising materials including at least one among Cr, Ti and Co, a UV-hardening etching resist was applied onto the underlayer 3, a quartz mold in which was formed a track-shape relief pattern was pressed against the etching resist applied film, the etching resist was hardened by irradiation with ultraviolet rays through the quartz mold, to form an etching pattern with pattern widths of 60 nm and pattern intervals of 40 nm, after which the underlayer 3 was etched along the etching pattern to form a relief pattern in the underlayer 3 having pattern widths of 60 nm, pattern intervals of 40 nm, and a pattern depth of 10 nm.

On the underlayer 3 with the relief pattern formed as described above, a magnetic layer 3 comprising a Co—Cr—Pt alloy was formed by evaporation deposition to a thickness of 10 nm, after which processes similar to those used in fabrication of Sample 1 in Example 1 were performed, forming on the magnetic layer 3 having the relief pattern a DLC film and a ta-C film, to fabricate a patterned magnetic recording medium with a magnetic layer 3 existing in the convex pattern and in the bottom portions of the concave pattern. In a metal elution test following sliding tests of the patterned magnetic recording medium thus obtained, results similar to those for Sample 1 of Example 1 were obtained. While the present invention has been described in conjunction with embodiments and variations thereof, one of ordinary skill, after reviewing the foregoing specification, will be able to effect various changes, substitutions of equivalents and other alterations without departing from the broad concepts disclosed herein. It is therefore intended that Letters Patent granted hereon be limited only by the definition contained in the appended claims and equivalents thereof.

What is claimed is:

1. A patterned magnetic recording medium, in which information recording regions are demarcated as a track-shape and/or dot-shape relief pattern, comprising:
a base;
an underlayer positioned on the base;
a magnetic layer positioned on the underlayer and having a relief pattern which corresponds to the information recording regions and which includes a convex pattern and a concave pattern;
a first protective layer covering the magnetic layer and having the relief pattern which includes the convex pattern and the concave pattern; and
a second protective layer formed on at least respective top portions of the convex pattern of the first protective layer and comprised of a tetrahedral-carbon (ta-C) film formed by an FCA method or by an FCVA method.

2. The patterned magnetic recording medium according to claim 1, wherein the information recording regions are demarcated by at least the convex pattern of the magnetic layer having the relief pattern.

3. The patterned magnetic recording medium according to claim 2, wherein the information recording regions are demarcated by both the convex pattern and by the concave pattern of the magnetic layer having the relief pattern.

4. The patterned magnetic recording medium according to claim 2, wherein the first protective layer comprises an inorganic film or a carbonaceous film formed by a CVD method.

5. The patterned magnetic recording medium according to claim 2, wherein that the first protective layer comprises a diamond-like carbon (DLC) film formed by a CVD method.

6. The patterned magnetic recording medium according to claim 1, wherein the information recording regions are demarcated by both the convex pattern and by the concave pattern of the magnetic layer having the relief pattern.

7. The patterned magnetic recording medium according to claim 6, wherein the first protective layer comprises an inorganic film or a carbonaceous film formed by a CVD method.

8. The patterned magnetic recording medium according to claim 6, wherein that the first protective layer comprises a diamond-like carbon (DLC) film formed by a CVD method.

9. The patterned magnetic recording medium according to claim 1, wherein the first protective layer comprises an inorganic film or a carbonaceous film formed by a CVD method.

10. The patterned magnetic recording medium according to claim 9, wherein the first protective layer comprises a diamond-like carbon (DLC) film formed by a CVD method.

11. The patterned magnetic recording medium according to claim 1, wherein the first protective layer comprises a diamond-like carbon (DLC) film formed by a CVD method.

12. The patterned magnetic recording medium according to claim 1, wherein the relief pattern includes the convex pattern which has respective top portions and a concave pattern which has respective bottom portions with corners, and wherein the first protective layer covers the magnetic layer in its entirety, including the respective bottom portions and corners thereof so that coverage is substantially complete and corrosion resistance is improved.

13. The patterned magnetic recording medium according to claim 1, wherein the relief pattern of the magnetic layer is a nanometer-order relief pattern, and wherein the convex portions have respective widths of 100 nm or less and the concave portions have respective depths of 50 nm or less.

14. The patterned magnetic recording medium according to claim 13, wherein the relief pattern of the magnetic layer is a nanometer-order relief pattern, and wherein the convex portions have respective widths of 10 nm to 60 nm and the concave portions have respective depths of 10 nm to 40 nm.

15. A method for manufacturing a patterned magnetic recording medium, comprising the steps of:
a. forming a magnetic layer, having a relief pattern which corresponds to a track-shape and/or dot-shape relief pattern demarcating information recording regions and which includes a convex pattern and a concave pattern, on an underlayer positioned on a base, by:
(1) forming an etching pattern of photohardening etching resist on the underlayer or the magnetic layer or a temporary protective layer; and
(2) etching the underlayer or magnetic layer or temporary protective layer and the magnetic layer along the etching pattern to form a relief pattern in the underlayer or the magnetic layer;
b. forming a first protective layer on the magnetic layer having the relief pattern by forming an inorganic film or a carbonaceous film by a plasma CVD method; and
c. forming a second protective layer comprising a ta-C film on at least respective top portions of the convex pattern of the first protective layer, by using an FCA method or an FCVA method.

16. The method for manufacturing a patterned magnetic recording medium according to claim 15, wherein the step of forming an etching pattern of a photohardening etching resist on the underlayer or magnetic layer or a temporary protective layer comprises:
applying the photohardening etching resist onto the underlayer or magnetic layer or the temporary protective layer;
pressing a quartz mold, having a relief pattern, onto the applied resist film in an imprinting method; and
irradiating with ultraviolet rays through the quartz mold to harden the resist to form the etching pattern.

17. The method for manufacturing a patterned magnetic recording medium according to claim 16, wherein the quartz mold has a nanometer-order relief pattern, and wherein the imprinting method is a nano-imprinting method.

18. The method for manufacturing a patterned magnetic recording medium according to claim 15, wherein forming the first protective layer is accomplished by forming a diamond-like carbon (DLC) film by a plasma CVD method.
